(19) United States
(12) Patent Application Publication
(10) Pub. No.: US 2007/0081690 A1
(43) Pub. Date: Apr. 12, 2007

(54) ELECTROLUMINESCENT LIGHTED HEADPHONES

(76) Inventors: Mary K. Stagni, Plymouth, MN (US); Lee D. Stagni, Plymouth, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/533,705

(22) Filed: Sep. 20, 2006

Related U.S. Application Data
(60) Provisional application No. 60/718,695, filed on Sep. 20, 2005.

(51) Int. Cl. H04R 25/00

(52) U.S. Cl. 381/384

(57) ABSTRACT

A control module adapted to connect to an energy source and having a headphone assembly connected to a first end of the control module. The control module further connected to an input wire assembly at a second end of the control module, wherein at least one of the headphone assembly and the input wire assembly is adapted to illuminate upon excitation by the energy source. Methods of operation are also described.

### RELATED APPLICATIONS

This application claims priority under 35 U.S.C. 119(e) to U.S. Provisional Patent Application Ser. No. 60/718,695, filed Sep. 20, 2005, which application is incorporated herein by reference.

This application is also related to the commonly assigned co-pending U.S. patent application Ser. No. 11/______, filed Sep. 20, 2006, entitled “Sound Meter for Portable Audio Headphones” by Mary K. Stagni et al.

### TECHNICAL FIELD

Embodiments of the inventive subject matter relate generally to consumer portable audio and gaming devices, and more particularly, but not by way of limitation, to portable audio headphones.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyrights whatsoever. Copyright 2006, Trick Audio, LLC.

### BACKGROUND

The success of products such as the Apple iPod, Sony Walkman, Sony Discman, etc. over the recent years indicates that the growth of a significant population of installed consumer portable audio devices is rising to a new level. The rapid growth of such products has resulted from the “cool factor” associated with these products, and has made them a “must have” among the younger generation.

There is significant competition in the earphone market, and successful market penetration requires a unique product. One popular style includes traditional headphones having two speakers that cup the entire ear of the wearer and hang over the top of the wearer's head. Some of the more contemporary styles include the “neckband” style which is similar to the traditional headphone but the speakers are generally placed directly against the ears with a connecting band that wraps around the back of the head or neck of the wearer. With the consumer need to provide better seal of the ear to the speaker and reduce extraneous noise, the more popular “earbud” style headphones are placed in the opening of the ear canal. This style is useful for low profile appearance and improved acoustic performance over the larger models. Additionally, many portable audio devices have improved lighted interface displays which serve multiple purposes from selecting listening mode to viewing various types of multimedia. For portability, such systems require auxiliary power which can be expended over long periods of time, requiring low power consumption or rechargeable capacity to maximize the operational useful life of the power source.

These technology advances have propelled the popularity of such products into as much a part of fashion as they are functional in their usage. In order to capture the attention of the changing market, a unique and versatile product is needed, without sacrificing portability.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 shows a control module and headphone assembly of one embodiment using EL wire.

FIG. 2 illustrates a cross section view of one wire assembly embodiment having two low voltage audio conductors and one electroluminescent (EL) wire conductor.

FIG. 3 shows a cross section view of one wire assembly embodiment having one low voltage audio conductor and one EL wire conductor, each having a separate but attached transparent insulator.

FIG. 4 illustrates a cross section view of one wire assembly embodiment having one low voltage audio conductor and one EL wire conductor.

FIG. 5 illustrates various embodiments of the display cover of the control module.

FIG. 6 illustrates a particular example of a control module embodiment for use with existing headphone assemblies.

FIG. 7 shows an example of the control module embodiment capable of adapting to an Apple iPod® multimedia player.

FIG. 8 illustrates an example of a control module and headphone assembly embodiment configured for use with a game system.

FIG. 9 illustrates an example of a control module and headphone assembly embodiment configured for use with a video game control module.

FIG. 10 is a is a flow diagram of an example of a method of measuring and displaying information about the signal transmitted through a control module embodiment similar to that illustrated in FIG. 6.

### DETAILED DESCRIPTION

The following detailed description includes references to the accompanying drawings, which form a part of the detailed description. The drawings show, by way of illustration, specific embodiments in which the invention may be practiced.

These embodiments, which are also referred to herein as “examples,” are described in enough detail to enable those skilled in the art to practice the invention. The embodiments may be combined, other embodiments may be utilized, or structural, logical and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In general, headphones are available with the purchase of a portable audio device or may be purchased separately as a replacement component. Many styles of headphones exist which include those that cup the ears of the user and rest over the head, those which are placed against the ears and rest either over the head or around the neck and those which rest on the outer surface of the ear canal (earbuds). It is the latter of those designs which has recently found increased market appeal due, in part, to the sales of Apple iPod® multimedia players. Although such portable audio devices generally are packaged with headphones, aftermarket replacement products offer unique features which make them more attractive and functional. The electrical and mechanical standards for connectivity are well established and the number of competitors is large. As a result, there exists a need to offer a product that distinguishes from others. Additionally, such a device should be lightweight and require low power consumption.

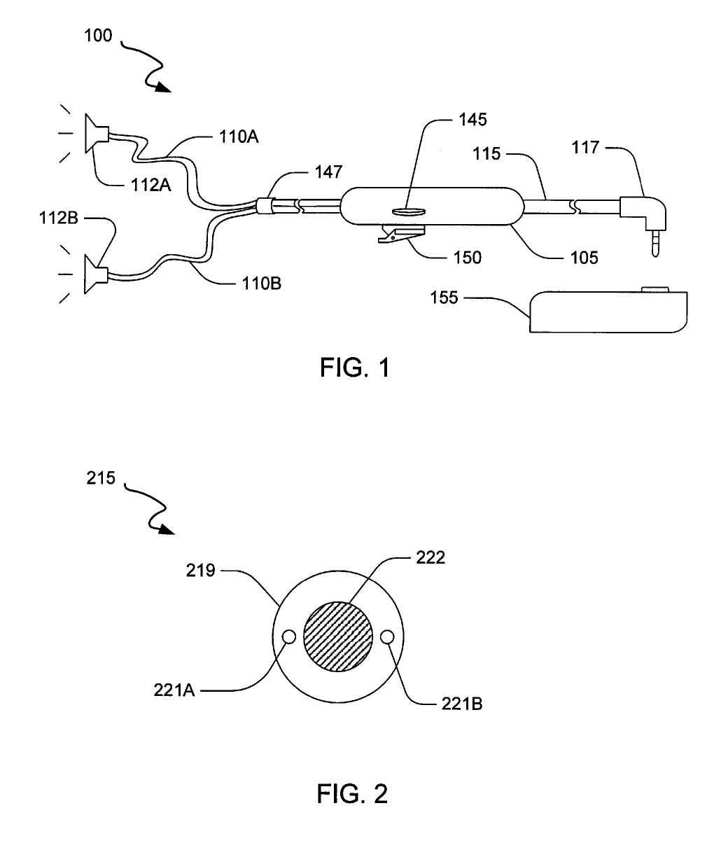

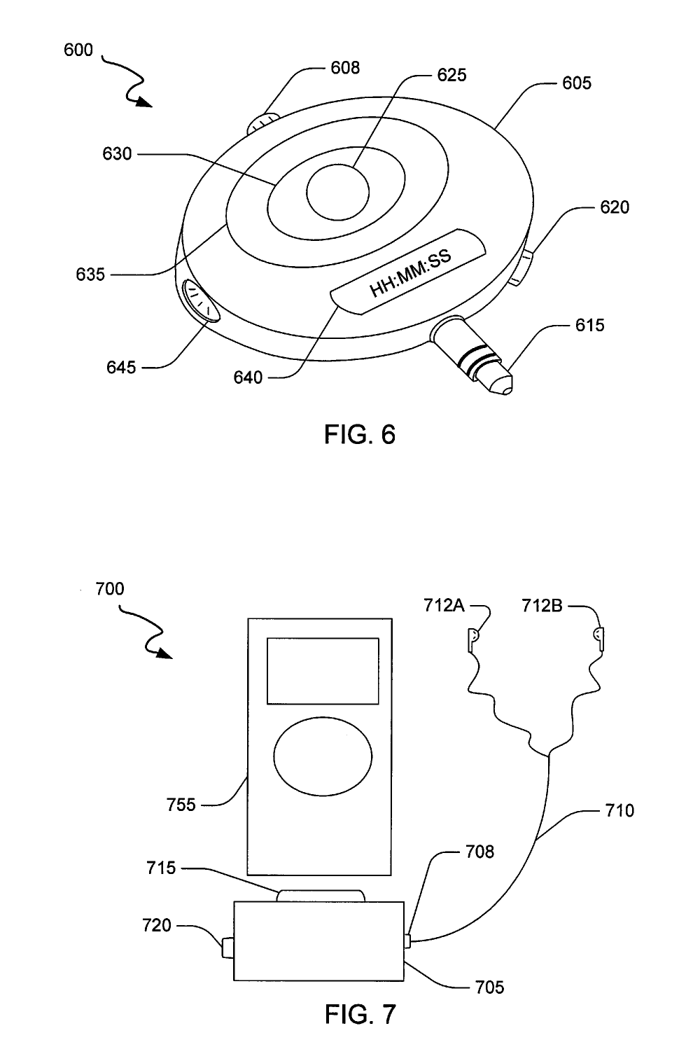

FIG. 1 illustrates an embodiment of a complete system 100 that includes the control module 105 having an input cable 115 for transmission of an audio input signal transmitted from a portable device 155 (CD player, MP3 device, radio, etc.) as connected by audio plug 117. In certain examples, the input cable 115 is constructed with phosphor encased low voltage conductors which will illuminate as electroluminescence, as dictated by the operation mode of the circuitry of control module 105. Electroluminescence is an optical and electrical phenomenon where a phosphrous coated material emits light in response to an electric current passed through it, or to a strong electric field passed near it. In certain examples the input cable 115 is constructed with wiring that provides memory retention such that a user can position or wrap the input cable 115 into a position that will remain so until repositioned. Operation modes may be user selectable as shown and described below in FIG. 6 (switch not shown in this illustration). Illumination intensity or sensitivity of synchronous mode operation can be controlled by intensity dial 145 as adjusted by the user. Fastener 150 provides the user with the ability to secure the control module 105 to an article of clothing while wearing the system 100. Alternatively, the system 100 may include a lanyard, thereby allowing the user to hang the control module 105 around the neck, similar to a necklace. Transmission of an audio signal from the control module 105 to transducers 112A and 112B occurs via the output conductors 110A and 110B which may or may not include EL capability. In certain examples the output conductors 110A and 110B include phosphor encased wiring such that the lighting modes selected by the user will illuminate output conductors 110A and 110B with intensity as determined by intensity dial 145. In certain examples the output conductors 110A and 110B are constructed with wiring that provides memory retention such that a user can position or wrap the output conductors 110A and 110B, independently into a position, such as draped around the ear, which will remain so until repositioned. Slider 147 provides the ability to adjust the distance between the two conductors 110A and 110B to customize the fit for a given user.

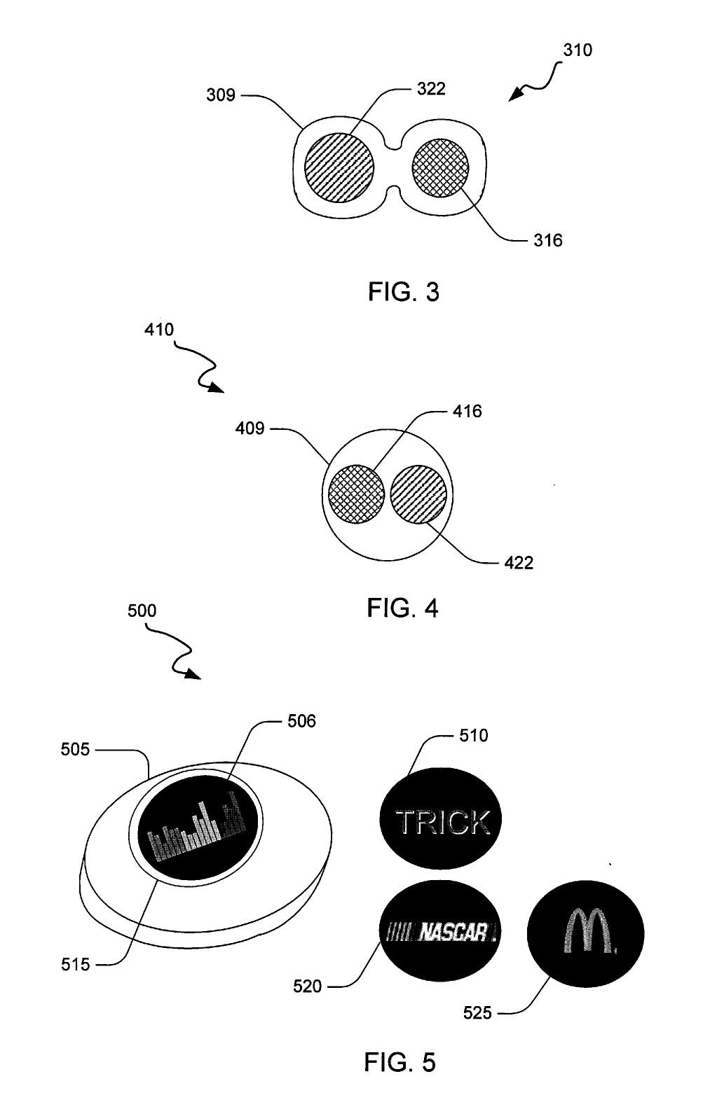

FIG. 2 provides a cross section view of an input wire 215 assembly, according to one embodiment in which a transparent insulator 219 encapsulates an embedded electroluminescent, EL, conductor 222 and two embedded audio signal conductors 221A and 221B. In this manner a single EL conductor 222 will light, as controlled by the control module 105, while the two signal conductors 221A and 221B will provide signal transmission of each channel of a binaural (two channel) signal. FIG. 3 illustrates a cross section view of an output or input conductor 310, according to one embodiment in which a transparent insulator 309 encapsulates an embedded EL conductor 322 and embedded audio signal conductor 316, such that each conductor is almost entirely separable at a junction between them. In this manner a single EL conductor 322 will light, as controlled by the control module 105 along side the signal transmission through output conductor 316 without crosstalk or interference. For further shielding, conductor 316 may further include a separate insulator within transparent insulator 309. FIG. 4 illustrates a cross section view of an output or input conductor 410, similar to conductor 310 illustrated in FIG. 3, according to one embodiment but having the conductors in close proximity. Transparent insulator 409 encapsulates an embedded EL conductor 422 and embedded audio signal conductor 416. In this manner a single EL conductor 422 will light, as controlled by the control module 105 along side the signal transmission through output conductor 416 but having lower profile as compared to that of FIG. 3.

FIG. 5 illustrates various embodiments of a replaceable display system 500 in which a large surface of the control module 505 may include an EL graphic panel 506, comprising EL sheets, which may contain a variety of graphic displays, in various styles and colors. The EL graphic panel 506 may further include a protective clear cover 507 used to secure the EL graphic panel 506 to the surface of the control module 505. In a further embodiment the protective clear cover 507 may be removable by the user to replace the EL graphic panel 506. The ability to change the EL graphic panel 506 accommodates a variety of graphic needs such as a bar graph display, a name 510, or trademarks 520 and 525. It is within the scope of the present disclosure that the user may change the display several times as needs change.

FIG. 6 illustrates generally, by way of example, but not by limitation, one example of portions of a system 600 which includes a control module 605, having a male audio input plug 615 designed to couple to industry-standard 3.5 mm (⅛^{th} inch) or 2.5 mm (cell phone) audio devices. Similarly, control module 605 may include a female audio output socket 608 designed to couple to similar device specifications as those for the male audio input plug 615.

Control module 605 is shown with an operation mode switch 620 providing the ability to power the device. In certain examples, the operation mode switch 620 may allow the user to change operation modes of the control module 605. According to one embodiment, the operation mode switch 620 provides lighting modes of constant on, pulsed, and synchronized which may be applied to a display screen similar to 506, shown in FIG. 5, and EL-enabled transducer wires, such as 110A and 110B, connected to output socket 608. In constant on mode, the lighted areas may illuminate at a fixed intensity during device operation. In pulsed mode, the lighted areas may alternate illumination according to a fixed or variable frequency. In synchronous mode, the lighted areas may illuminate in time with the music. In certain examples, the illumination of the EL-enabled wire in synchronous mode may travel the length of the wires such that higher sensitivity of the signal occurs at the first end closest to output socket 608 and lower sensitivity of the signal occurs at the opposite end, or vice versa.

Graphic display zone one 625, zone two 630 and zone three 635 may be used to graphically represent the measured sound level in dB or alternatively use colors to represent predetermined dB ranges as measured by control module 605. It is anticipated that an alternative use of the graphic display is to advertise illuminated trademarks or similar personal identifying marks similar to those illustrated in FIG. 5. The time display 640 may provide time elapsed during audio transmission, displayed in hours, minutes and seconds (HH:MM:SS or 00:00:00). In certain examples, the time may be reset to zero or “00:00:00” with a toggle of the device power, such as the operation mode switch 620, and the circuitry of the control module 605 sensing a transmitted signal. Alternatively, the time display 640 may reset after a predetermined time has elapsed since the last sensed transmitted signal, such as a period of ninety seconds.

In certain examples, the circuitry of the control module 605 may determine relative loudness thresholds associated with a particular color for each of three graphic display zones (zone one 625, zone two 630 and zone three 635). The loudness can be measured as a function of the sound level of the audio signals transmitted through the control module 605, measured in decibels (dB), over a period of time. High levels of sound may produce hearing loss such that the higher the sound level, the shorter period of time is required to produce hearing loss, whereas a lower sound level over a longer period of time may produce a similar result, but less conspicuously.

Although many adults may be aware of the potential hearing loss associated with high sound levels of portable music devices, it is children who are at risk through either lack of knowledge or appreciation. Therefore, parents who desire to offer such sound products to their children may also desire to monitor the two primary metrics associated with over exposure to harmful sound levels (sound level in dB and time). Detecting sound level and play time may be most effective in the transmitting device, where the signals are self-contained and less likely exposed to external ambient noise.

The measurement decibel refers to the intensity of sound pressure level discernable by the human ear. Due to the range of sensitivity of the human ear, on average from 20 Hz to 20 kHz, the smallest perceivable change by a human is believed to be 1 dB but typically 3 dB is the practical standard. In air, sound pressure levels above 85 dB are considered harmful, while 95 dB is considered unsafe for prolonged periods and 120 dB causes an immediate perforation of the ear drum (tympanic membrane). Windows break at about 163 dB.

In such an example zone one 625 could correspond to measured sound levels in the “safe” range of 1-70 dB, zone two 630 could correspond to measured sound levels in the “caution” range of 71-90 dB, zone three 635 could correspond to measured sound levels in the “danger” range of over 91 dB. It is within the scope of the embodiments described herein that a variety of EL sheets or light emitting diodes (LEDs) in different colors and intensity may be made available to users to decorate and distinguish the different zones from one another. The intensity dial 645 may provide adjustment of the intensity of the lighted display and any attached EL-enabled speaker wires to accommodate different lighting conditions. In certain examples the intensity dial 645 may adjust the sensitivity of any attached EL-enabled speaker wires when utilized in synchronous mode.

FIG. 7 illustrates a system 700 using an Apple iPod® multimedia player with the system described in FIG. 1. Due to the specialized connectors associated with such audio devices the system 700 must include an interface commonly referred to as an “ipod® connector.” The iPod device (iPod®, ipod Nano®, etc.) 755 may connect to interface connector 715 on the surface of control module 705. Other features, similarly used on 105 and 605 include operation mode switch 720 and output socket 708. In certain examples an EL-enabled wire assembly 710 includes phosphor encased conductor wires and transducers 712A and 712B, which will provide illumination of the wires as determined by the control module 105 and 605.

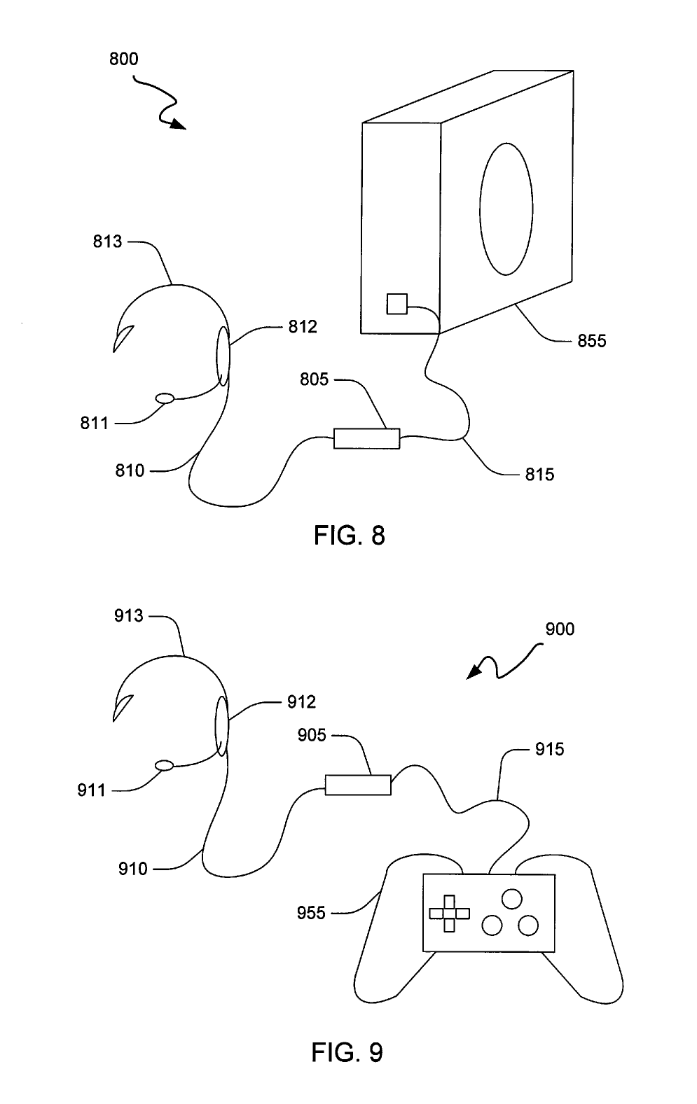

FIG. 8 illustrates a system 800, according to one embodiment, which includes a control module 805 which connects to a game console or personal computer 855. The control module 805 may receive both a power source and audio signals from the game console or personal computer 855 through input cable 815 which connects to the game console or personal computer 855 using a standard interface connector such as the USB connector. The control module 805 may then transmit the received signals to a headset 813, via output conductors 810, which may have one or more speaker transducers 812 along with a microphone 811. This combination of microphone 811 and speaker transducers 812 are popular with multi-player video game enthusiasts for role playing games (RPGs) in which multiple players communicate with each other during game play. In this example, the output conductors 810 and input cable 815 may be illuminated as controlled by the control module 805 while receiving its energy source from the game console or personal computer 855. Alternatively, control module 805 may utilize batteries as an energy source.

FIG. 9 illustrates a system 900, according to one embodiment, which includes a control module 905 which connects to a video game controller 955. The control module 905 may receive both a power source and audio signals from the game controller 955 through input cable 915 which connects to the game controller 955 using a standard interface connector such as the USB connector, or alternatively a proprietary connector as defined by the gaming device. The control module 905 may then transmit the received signals to a headset 913, via output conductors 910, which may have one or more speaker transducers 912 and microphone 911. It is anticipated that the control modules of either 805 or 905 could maintain the same functionality as those obtained by 105 and 605 above. Additionally, other control signals may be further anticipated such as those which provide force feedback such as a vibration timed with action in a video game.

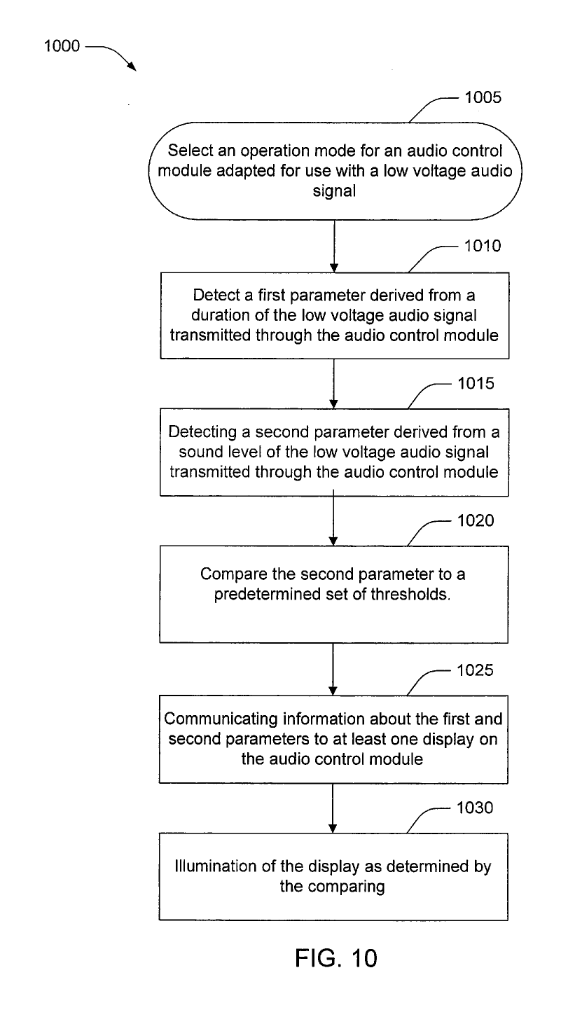

FIG. 10 is a is a flow diagram of a system 1000 illustrating an example of a method of detecting audio signal parameters utilizing a control module similar to that illustrated in FIG. 1 and FIG. 6 and communicating information about the signal to a display on the device. At 1005, an operation mode is selected for use with a low voltage audio signal. Examples of operation modes include EL wire and graphical display lighting modes of constant on, pulsed, and synchronized to the audio signal, as described above. At 1010, a first parameter is derived from a duration of the low voltage audio signal transmitted through an audio control module such as that of 105 and 605. At 1015, a second parameter is derived from a sound level of the low voltage audio signal transmitted through the control module such as the sound pressure (dB) transmitted through control modules 105 and 605. At 1020, the second parameter is compared to a predetermined set of thresholds to determine the illumination of the information on a display. Examples include measured sound levels in ranges from “safe” (1-70 dB), to “caution” (71-90 dB), and “danger” (over 91 dB). At 1025, the information obtained from the thresholds of 1020 can then be communicated to the user through at least one display. At 1025, the display may have three zones of different colors to indicate which of the three sound level thresholds were breached. In certain examples, a control module 105 or 605 may determine relative loudness thresholds associated with a particular color for each of three graphic display zones (zone one 625, zone two 630 and zone three 635). In such an example zone one 625 could correspond to measured sound levels in the “safe” range, zone two 630 could correspond to measured sound levels in the “caution” range, and zone three 635 could correspond to measured sound levels in the “danger” range. At 1030, the illumination of the display is determined by the compare step.

The scope of the invention should, therefore, be determined with reference to the appended claims. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus the following claims are hereby incorporated into the Detailed Description, with each claim standing on its own as a separate embodiment.

What is claimed is:

1. An apparatus comprising:
a control module adapted to connect to an energy source;
a headphone assembly connected to a first end of the control module; and
an input wire assembly connected to a second end of the control module, wherein at least one of said headphone assembly and input wire assembly is adapted to illuminate upon excitation by the energy source.

2. The apparatus of claim 1, in which the control module further comprises a mode switch adapted to enable at least one operation mode.

3. The apparatus of claim 2, in which the operation mode includes one or more of constant on, pulsed, and synchronized.

4. The apparatus of claim 1, in which at least one of the headphone assembly and the input wire assembly includes at least one phosphor encased conductor.

5. The apparatus of claim 1, in which the control module further comprises an illumination control switch adapted to adjust the illumination intensity of the at least one phosphor encased conductor.

6. The apparatus of claim 1, in which at least one of the headphone assembly and the input wire assembly includes memory retention wire.

7. The apparatus of claim 1, in which the input wire assembly is adapted to terminate to a male audio plug and further having a length approximately equal that of the headphone assembly.

8. The apparatus of claim 1, in which the headphone assembly further comprises at least two conductors having a slider adapted to adjust the distance between the two conductors.

9. The apparatus of claim 1, in which the control module further comprises an intensity control configured to adjust the illumination intensity of at least one of the headphone assembly and the input wire assembly.

10. The apparatus of claim 1, in which control module further comprises a battery adapted to provide the energy source.

11. The apparatus of claim 1, in which the control module further comprises a fastener adapted to secure at least a portion of the control module to an item of clothing worn by a user.

12. The apparatus of claim 1, in which the control module further comprises a lanyard adapted to secure at least a portion of the control module to a user.

13. An apparatus comprising:
a first wire assembly, at least a portion of which is adapted to illuminate upon excitation by an energy source, wherein the wire assembly comprises:
a first phosphor encased conductor;
a second phosphor encased conductor; and
an insulator, at least a portion of which is adapted to encapsulate the first and second conductors wherein the insulator is substantially transparent; and
a control module coupled to a first end of the first wire assembly, at least a portion of which is adapted to illuminate upon excitation by an energy source, wherein the control module further comprises:
an energy source;
control circuitry configured to measure a first parameter from the audio input; and
a lighted display.

14. The apparatus of claim 13, wherein the first wire assembly further comprises memory retention wire.

15. The apparatus of claim 13, further comprising a second wire assembly having at least one phosphor encased conductor connected to the input port of the control module, having length approximately equal to the first wire assembly and a first end adapted to terminate to a male audio plug.

16. The apparatus of claim 15, wherein the second wire assembly is further adapted to retain position upon placement by a user.

17. The apparatus of claim 13, in which at least a portion of a second end of the first and second conductors of the first wire assembly is adapted to terminate to one or more of an headphone, a speaker and a microphone.

18. The apparatus of claim 13, in which a distance between the first and second phosphor encased conductors is adjustable by a user via a slider.

19. The apparatus of claim 13, in which the control module further comprises a fastener adapted to secure at least a portion of the control module to an item of clothing worn by the user.

20. The apparatus of claim 13, in which the control circuitry of the module further comprises an illumination module configured to control the illumination of the first and second wire assemblies in one or more of a constant illumination mode, a pulsed illumination mode and a synchronized illumination mode, as selected by a user.

21. The apparatus of claim 13, in which the lighted display further comprises a display cover connected to at least the circuit board, the display cover further comprising a sheet of encased phosphor and adapted to illuminate concurrently with one or more of the illumination modes as selected by the user.

22. The apparatus of claim 13, in which the lighted display is adapted to illuminate as a function of the measured first parameter.

23. The method comprising:
selecting an operation mode for an audio control module adapted for use with a low voltage audio signal;
detecting a first parameter derived from a duration of the low voltage audio signal transmitted through the audio control module; and
communicating information about the first parameter to at least one wire assembly connected to the audio control module.

24. The method of claim 23, in which the detecting a first parameter includes measuring the sound level of a transmitted signal.

25. The method of claim 24, in which the communicating information further comprises illumination of the display as determined by the detecting.

26. The method of claim 25, in which the illumination further comprises exciting a phosphor encased low voltage conductor as determined by the selecting.
